(19) United States
(12) Patent Application Publication
(10) Pub. No.: US 2016/0303828 A1
(43) Pub. Date: Oct. 20, 2016

(54) MOBILE ELECTRONIC PARTS

(71) Applicant: SOLVAY SPECIALTY POLYMERS USA, LLC, Alpharetta, GA (US)

(72) Inventors: Suresh R. SRIRAM, AURORA, IL (US); Gregory C. PLITHIDES, Los Gatos, CA (US)

(21) Appl. No.: 15/103,040

(22) PCT Filed: Dec. 8, 2014
(86) PCT No.: PCT/EP2014/076825

§ 371 Date: Jun. 9, 2016

Related U.S. Application Data
(60) Provisional application No. 61/915,022, filed on Dec. 12, 2013.

(51) Int. Cl. B32B 15/08; B29C 45/16; B29C 43/02; B32B 15/20; B32B 27/28

(52) U.S. Cl. CPC B32B 15/08; B32B 15/20; B32B 27/285; B32B 27/286; B29C 43/02; B29C 45/16; B32B 2457/00; B29K 2081/06

(57) ABSTRACT

A mobile electronic part consisting of: (i) a pre-treated shaped metal part wherein the metal is selected from a group consisting of magnesium, aluminum and alloys of these metals, and (ii) an overmolded composition layer [layer (C), herein after] bonded onto said pre-treated shaped metal part wherein said composition comprises at least one poly(ethersulfone) polymer [(PESU) polymer herein after].

### CROSS-REFERENCE TO RELATED APPLICATION

This application claims priority to U.S. provisional application No. 61/915,022 filed Dec. 12, 2013, the whole content of this application being incorporated herein by reference for all purposes

### TECHNICAL FIELD

The present invention relates to mobile electronic parts consisting of a thermoplastic resin composition layer being fixed onto a pre-treated shaped metal part, said mobile electronic parts having excellent chemical resistance and good mechanical properties. The invention further relates to mobile electronic devices comprising said mobile electronic parts, to methods of manufacturing said mobile electronic parts and said mobile electronic devices.

### BACKGROUND ART

Nowadays, many mobile electronics devices, such as mobile phones, tablets, laptop computers, MP3 players, and the like, have a significant portion of the device made out of low density metal such as magnesium, aluminum and alloys thereof. Since the use of metals for mobile electronics parts comes with certain drawbacks, for example, magnesium is somewhat expensive and their use sometimes limits design flexibility, most of the mobile electronics devices also comprise polymeric parts.

As the mobile electronic devices and the parts therein are getting thinner and smaller for even more portability and convenience, methods which make it possible to directly bond metals and polymeric components together are important when considering volume reduction of the device. In these methods, there is thus a high need to ensure integrally bonding between the metal part, in particular aluminium part and polymeric components.

Nano molding technology (NMT) is a technique of integrally bonding a metal and a resin, which allows the resin to be directly injection molded on a surface of a metal sheet by nano-molding the surface of the metal sheet so as to obtain a metal-resin integrally molded product. For effective bonding of a metal and a resin, NMT may replace commonly used insert molding or zinc-aluminum or magnesium-aluminum die casting so as to provide a metal-resin integrally molded product with low cost and high performance. Compared with the bonding technology, NMT may reduce the whole weight of the product, and may ensure excellent strength of the mechanical structure, high processing rate, high output, and many appearance decoration methods, and consequently may apply to mobile electronic devices and parts. As already briefly explained, the Nano Molding Technology (NMT-method) is a method which makes it possible to directly bond metals, in particular aluminium, and plastics together. This method comprises pre-treating the metal surface, including etching with various chemicals, and then injection molding the desired plastic components on the treated surface. The NMT method has already been applied for polyphenylene sulfide (PPS) resins, polybutylene terephthalate (PBT) resins and is also effective for aromatic polyamide resins such as for the commercially available Kalix® modified polyarylamide polymer from Solvay Specialty Polymers U.S.A, L.L.C. The advantage of this method is the possibility to manufacture light and strong products.

Additionally, anodization is an important electro chemical process that is typically carried out on metal parts of mobile devices, including aluminum/plastic composite parts, aimed at building an oxide layer on the aluminum surface for improving corrosion protection. Other reasons for anodizing are notably maintaining the “new-look”, obtaining a dirt-repelling surface, obtaining a decorative colored surface, obtaining a touch appealing surface, obtaining a surface resistant to wear and obtaining an electrical insulating surface. In this regards, as anodization is performed on parts already comprising polymeric layers, a need for polymeric materials with excellent chemical resistance to various aggressive acids exists.

However, polymeric materials possessing excellent chemical resistance, such as notably commercially available poly(etheretherketone) (PEEK) resins or polyetherimide (PEI) resins are not endowed with adequate adhesion properties to metal surfaces; hence, for ensuring cohesion with metal parts, these latter have a geometry that allows a mechanical interlock between the metal part and the polymeric part.

As mentioned above, as parts get smaller there is thus also a high demand to avoid mechanical interlocking.

Despite the fact that the mobile electronic devices and the parts therein are getting thinner and smaller, they still need to possess a certain structural strength and stiffness so that they will not be damaged in normal handling and occasional drops.

In view of all the above, there is thus a continuous need for lighter and smaller mobile electronic devices and structural parts therein which have at the same time excellent chemical resistance and good mechanical properties such as notably improved ductility (i.e. good elongation properties), impact resistance, high stiffness (and in particular high flexural modulus), as well as strength, thus having the necessary structural integrity and breakage resistance required under for example the harsh drop testing conditions.

### SUMMARY OF INVENTION

The present invention addresses the above detailed needs and relates to a mobile electronic part consisting of:
(i) a pre-treated shaped metal part wherein the metal is selected from a group consisting of magnesium, aluminum and alloys of these metals, and
(ii) an overmolded composition layer [layer (C), herein after] bonded onto said pretreated shaped metal part wherein said composition comprises at least one poly(ethersulfone) polymer [(PESU) polymer herein after].

The invention further pertains to a method for making the above mentioned mobile electronic part.

The invention also pertains to a mobile electronic device comprising the above mentioned mobile electronic part.

### DETAILED DESCRIPTION OF THE PRESENT INVENTION

The Pre-Treated Shaped Metal Part

As said, the metal of the pre-treated shaped metal part is selected from a group consisting of magnesium, aluminum and alloys of these metals. A preferred metal is aluminum alloy.

In a preferred embodiment of the present invention, the pre-treated shaped metal part is a pre-treated shaped aluminum alloy part. An aluminum alloy is known for its low density, high strength, good workability and tooling and together with its high resistance to corrosion. Aluminum alloys have notably a tensile strength of 70 to 700 MPa.

In the present invention, various aluminum alloys can be used such as notably those standardized as “1000 series” to “7000 series” by JIS (Japanese Industrial Standards) and those of die-casting grade.

An example of a suitable aluminum alloy is for example Al 5052 H32 is a wrought alloy with Mg as the main alloying element, 2.2-2.8%. Other alloying elements are: Cr 0.15-0.35%; Cu 0.1%; Fe 0.4%; Mn 0.1%; Si 0.25% and Zn 0.1%.

The expression “pre-treated” is understood, within the context of the present invention, to designate the result on the shaped part of a pre-treatment process, preliminary to the overmolding, said process including at least one of (1) cleaning; (2) mechanically roughening; (3) etching with various chemicals.

The Composition of Layer (C) [Composition (C), Herein after]

The composition (C) comprises advantageously the at least one (PESU) polymer in an amount of more than 50% wt., preferably in an amount of more than 70% wt., preferably more than 80% wt., more preferably more than 90% wt., still more preferably more than 95% wt., even more preferably more than 99% wt., based on the total weight of the composition (C).

If desired, the composition (C) may consist of the at least one (PESU) polymer.

### The Poly(Ethersulfone) Polymer

Within the context of the present invention the mention “at least one poly(ethersulfone) polymer [(PESU) polymer herein after]” is intended to denote one or more than one (PESU) polymer. Mixtures of (PESU) polymer can be advantageously used for the purposes of the invention.

In the rest of the text, the expressions “(PESU) polymer” are understood, for the purposes of the present invention, both in the plural and the singular, that is to say that the inventive composition may comprise one or more than one (PESU) polymer.

For the purpose of the invention, the term “poly(ethersulfone) polymer [(PESU) polymer]” is intended to denote any polymer of which more than 50% by moles of the recurring units are recurring units (R_{PESU}) of formula (A), herein below:

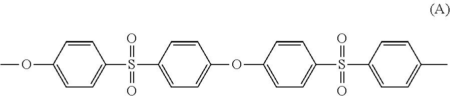

In a preferred embodiment of the present invention, more than 75% by moles, preferably more than 90% by moles, more preferably more than 99% by moles, even more preferably substantially all the recurring units of the (PESU) polymer are recurring units (R_{PESU}) of formula (A), chain defects or minor amounts of other recurring units might be present, being understood that these latter do not substantially modify the properties of the (PESU) polymer.

The (PESU) polymer, as described above, may be notably a homopolymer, or a copolymer such as a random or a block copolymer. When the (PESU) polymer is a copolymer, its recurring units are advantageously a mix of (R_{PESU}) of formula (A) and of recurring units (R_{PESU}*). These recurring units (R_{PESU}*) can notably be selected from the group consisting of those of formulae (B), (C) and (D), as represented hereafter:

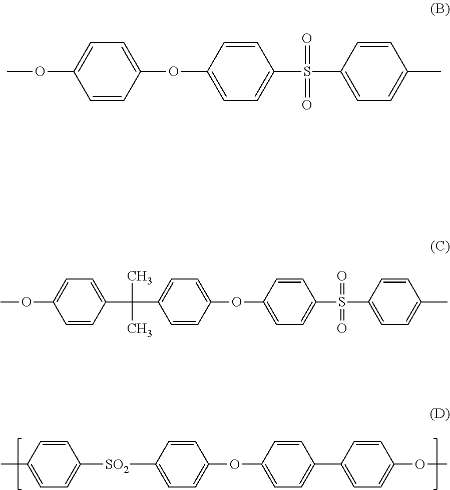

and mixtures thereof.

The (PESU) polymer can also be a blend of the previously cited homopolymer and copolymer.

The (PESU) polymers can be prepared by known methods.

The (PESU) polymer has advantageously a melt flow rate (MFR) equal to or higher than 4 g/10 min at 380° C. and under a load of 2.16 kg, preferably equal to or higher than 7 g/10 min at 380° C. and under a load of 2.16 kg, more preferably equal to or higher than 15 g/10 min at 380° C. and under a load of 2.16 kg, as measured in accordance with ASTM method D1238; to measure said melt flow rate, a Tinius Olsen Extrusion Plastometer melt flow test apparatus can be used.

Upper boundary for the melt flow rate of the (PESU) polymer is not critical and will be selected by the skilled in the art as a matter of routine work. It is nevertheless understood that when the (PESU) polymer possibly comprised in the composition (C) possesses advantageously a melt flow rate of at most 100 g/10 min, preferably at most 80 g/10 min, more preferably at most 70 g/10 min, still more preferably at most 60 g/10 min, most preferably at most 50 g/10 min, when measured in accordance with ASTM method D1238 at 380° C. and under a load of 2.16 kg.

According to certain embodiments, the (PESU) polymer can have a melt flow rate of 50 g/10 min or less, preferably of 40 g/10 min or less at 380° C. and under a load of 2.16 kg, preferably of 25 g/10 min or less at 380° C. and under a load of 2.16 kg: in other words, the (PESU) polymer of this embodiment will have a melt flow rate, measured as above detailed, ranging from at least 4 g/10 min to 50 g/10 min or less, preferably ranging from at least 15 g/10 min to 40 g/10 min or less, at 380° C. and under a load of 2.16 kg. VERADEL® A-201 NT, VERADEL® A-301 NT, VERADEL® A-702, VERADEL® A-704, VERADEL® 3100, VERADEL® 3200 VERADEL® 3300, VERADEL® 3400, VERADEL® 3500, VERADEL® 3600 are examples of PESU polymers suitable for being used in this embodiment.

The VERADEL® PESU weight average molecular weight can be 20,000 to 100,000 grams per mole (g/mol) as determined by gel permeation chromatography using ASTM D5296 with polystyrene standards. In some preferred embodiments the VERADEL® PESU weight average molecular weight can be 30,000 to 60,000 grams per mole (g/mol).

According to certain embodiments, the (PESU) polymer can be functionalized by one or more functional groups.

For the purpose of the present invention, the functional group may have bonding to atoms of the polymer chain, as a side chain group [side group] or be present as polymer chain end groups [end group]. Preferably, the functional group is a functional end group.

The functional group in the (PESU) polymer is preferably selected from a group consisting of hydroxyl, in particular phenol OH, carboxyl (—COOA where A is hydrogen or an alkali metal, anhydride and epoxide groups.

The functional group in the (PESU) polymer is most preferably a phenol OH group.

In a preferred embodiment of the present invention, the (PESU) polymer has advantageously a number of phenol OH groups being equal to or more than 10 μeq/g, preferably equal to or more than 20 μeq/g, more preferably equal to or more than 30 μeq/g, even more preferably equal to or less more than 50 μeq/g.

Upper boundary for the number of phenol OH group of the (PESU) polymer is not critical and will be selected by the skilled in the art as a matter of routine work. It is nevertheless understood that the (PESU) polymer has advantageously a number of phenol OH groups being equal to or less than 400 μeq/g, preferably equal to or less than 300 μeq/g, more preferably equal to or less than 200 μeq/g, even more preferably equal to or less than 100 μeq/g.

Analytical methods can be used for the determination of the total number of functional groups in the (PESU) polymer, including notably titration methods, spectroscopic measurements such as IR and NMR or radioactive measurements such as for polymers with labeled end-groups.

Preferably, the total number of phenol OH groups in the (PESU) polymer of the present invention are suitably determined by a titration method, preferably a potentiometric titration method.

For the determination of the total number of phenol OH groups, a base is suitably used as titrant. Suitable bases are in general those having a K_{b} value equal to of at least 1000 times greater than the K_{b} value of the de-protonated carboxyl end group. A suitable bases is notably tetrabutylammonium hydroxide in a mixture of toluene and methanol.

The base is in general dissolved in an organic solvent. The organic solvent to be used may, for example, be toluene, dimethyl formamide, dimethyl acetamide, dimethylsulfoxide, sulfolane, tetrahydrofuran, acetonitrile, dioxane, methanol, ethanol and mixture thereof.

The Applicant has surprisingly found that free reactive hydroxyl groups advantageously enhance the binding to the pretreated shaped metal part.

The methods for achieving functionalized (PESU) polymers are well known in the art and include notably conducting the reaction with excess of the Bisphenol S monomer.

For example, a polymer commercialized by Solvay Specialty Polymers USA, L.L.C. as Virantage® 10200, Virantage® 10300, and Virantage® 10700 functionalized polyethersulfones (r-PESU) comply with this criterion.

### Optional Ingredients

According to certain embodiments, the composition (C) of the present invention may optionally comprise a reinforcing filler.

A large selection of reinforcing fillers may be added to the composition (C). It is understood that the skilled person will easily recognize the reinforcing filler which fits best its composition and encompassed end uses. Generally, the reinforcing filler is chosen depending on its chemical nature, its length, diameter, ability to feed nicely in compounding equipment without bridging and surface treatment (notably because good interfacial adhesion between the reinforcing filler and the polymer improves the strength and the toughness of the blend).

They are preferably selected from fibrous and particulate fillers.

A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5. Preferably, the aspect ratio of the reinforcing fibers is at least 10, more preferably at least 20, still more preferably at least 50.

In one embodiment, the reinforcing fibrous filler may be selected from glass fibers; carbon fibers such as notably graphitic carbon fibers (some of them having possibly a graphite content of above 99%), amorphous carbon fibers, pitch-based carbon fibers (some of them having possibly a graphite content of above 99%), PAN-based carbon fibers; synthetic polymeric fiber; aramid fiber; aluminum fiber; aluminum silicate fibers; oxide of metals of such aluminum fibers; titanium fiber; magnesium fiber; boron carbide fibers; rock wool fiber; steel fiber; asbestos; wollastonite; silicon carbide fibers; boron fibers, graphene, carbon nanotubes (CNT) and the like. Glass fibers are most preferred.

In another embodiment, the fillers are non-fibrous and may be selected from talc, mica, titanium dioxide, kaolin, calcium carbonate, calcium silicate, magnesium carbonate and Zinc sulfide.

When the reinforcing filler is present in the composition (C), the at least one reinforcing filler is present in an amount of advantageously at least 5 wt. %, preferably at least 10 wt. %, more preferably at least 15 wt. %, based on the total weight of the composition (C).

The reinforcing filler is also present in an amount of advantageously at most 50 wt. %, preferably at most 45 wt. %, more preferably at most 40 wt. %, still more preferably at most 30 wt. %, based on the total weight of the composition (C).

The composition (C) may further optionally comprise other ingredients such as a colorant such as notably a dye and/or a pigment, ultraviolet light stabilizers, heat stabilizers, antioxidants, an acid scavenger, processing aids, nucleating agents, an internal lubricant and/or an external lubricant, flame retardants, a smoke-suppressing agent, an anti-static agent, an anti-blocking agent, and/or conductivity additive such as carbon black and carbon nanofibrils.

When one or more other ingredients are present, their total weight, based on the total weight of composition (C), is usually below 50%, preferably below 20%, more preferably below 10% and even more preferably below 5%.

Composition (C) is comprised in the mobile electronic part in an amount of advantageously at least 1 wt. %, preferably at least 5 wt. % and still more preferably at least 10 wt. %, based on the total weight of the mobile electronic part.

Besides, composition (C) is comprised in the mobile electronic part in an amount of advantageously at most 99 wt. %, preferably at most 95 wt. % and still more preferably at most 80 wt. %, the total weight of the mobile electronic part.

### The Layer (C)

The thickness of the layer (C) is advantageously of at most 5000 μm, preferably of at most 3000 μm, more preferably of at most 1500 μm and even more preferably of at most 250 μm.

In a preferred embodiment, the thickness of the layer (C) ranges from 100 to 3000 μm, more preferably from 250 to 2000 μm.

### The Mobile Electronic Part

For the purpose of the present invention, the term “mobile electronic part” is intended to denote any part present in a mobile electronic device.

The term “mobile electronic device” is intended to denote an electronic device typically having a display screen with touch input and/or a miniature keyboard and is designed so that it can be conveniently be transported and used in various locations. Representative examples of mobile electronic devices include mobile electronic phones, personal digital assistants, laptop computers, tablet computers, radios, cameras and camera accessories, watches, calculators, music players, global positioning system receivers, portable games, hard drives and other electronic storage devices, and the like.

Preferred mobile electronic devices are laptop computers and mobile electronic phones. Most preferred mobile electronic device is a mobile electronic phone.

The mobile electronic part according to the present invention may be selected from a large list of articles such as fitting parts, snap fit parts, screw bosses parts, mutually moveable parts, functional elements, operating elements, tracking elements, adjustment elements, carrier elements, frame elements, films, in particular speaker films, switches, connectors, cables, housings, any structural part integrated on housings and any other structural part other than housings as used in a mobile electronic devices, such as for example speaker parts, antenna components and support elements, keypad buttons, battery cover, front cover.

By “mobile electronic device housing” is meant one or more of the back cover, front cover, antenna housing, frame and/or backbone of a mobile electronic device.

The housing may be a single article or comprise two or more components.

Non-limiting examples of structural parts integrated on housings mention can notably be made of ribs, screw bosses, snap-fits and the like, all integrally bonded to the inner surface of a housing.

By “backbone” is meant a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas.

The mobile electronic device housing is preferably selected from the group consisting of a mobile phone housing, a tablet housing, a laptop computer housing and a tablet computer housing.

The Applicant has surprisingly found that the mobile electronic parts according to the present invention has excellent chemical resistance properties to various aggressive acids and thus has improved chemical resistance over prior art mobile electronic parts.

Another objective of the present invention is to provide a method for the manufacture of the above described mobile electronic parts comprising the following steps:
Step 1—pre-treating at least part of the surface of a shaped metal part, wherein the metal is selected from a group consisting of magnesium, aluminum and alloys of these metals, and
Step 2—forming an overmolded composition layer [layer (C)], as described above, onto said pretreated shaped metal part by overmolding the composition (C), as described in detail above, onto said pretreated shaped metal part by using conventional overmolding techniques.

### Pre-Treating Step—Step 1

Generally, pre-treating step will include at least one of (1) cleaning; (2) mechanically roughening; (3) etching with various chemicals of the said at least part of the surface of the said shaped metal part.

Among (1) cleaning treatments, mention can be notably made of steps of washing/rinsing, to remove grease and other contaminants which might interfere with adhesion. It is preferable to perform washing with an organic solvent and/or rinsing with water in combination, depending on the kind of contamination. If a water-soluble organic solvent, e.g. acetone, methanol, or ethanol, is used, it is easy to remove the organic solvent by rinsing with water after the shaped metal part has been dipped in the organic solvent to remove oily contamination. If oily matter is firmly attached to the surface, it may be washed with an organic solvent, e.g. benzene, or xylene.

As (2) mechanical roughening treatments are concerned, these steps are generally required when the pre-treated shaped metal part need to have an increased surface roughness. As (2) mechanical roughening treatments, known surface abrasive treatment processes including notably grit blasting, flame spraying, polishing, sandblasting, shot blasting, grinding, or barreling and the like, can be carried out on at least part of the surface of the shaped metal part. Said surface treatment processes are also advantageously effective as removing for example an oil or fat layer left on the surface of the shaped metal part after the machining processes, described below, a rust layer formed by oxidation or hydroxidation, peeling off an oxide layer, a corrosion product layer, and the like.

As said, the above described (2) mechanical roughening treatments advantageously increase the surface roughness, thereby enhancing the bond effect between the surface of the pretreated shaped metal part and the layer (C).

As examples of techniques of (3) etching with various chemicals, mention can be notably made of (i) Alkali Etching; (ii) Neutralization (Acid) Treatment; and (iii) T-treatment (contact treatment).

As per the (i) Alkali Etching, according to this variant, at least part of the surface of a shaped metal part is dipped in a basic aqueous solution (pH>7). It is generally rinsed with water. Examples of bases usable in the basic aqueous solution are alkali metal hydroxides, such as sodium hydroxide (NaOH) and potassium hydroxide (KOH), soda ash (Na₂CO₃; anhydrous sodium carbonate), which is a low-cost material containing an alkali metal hydroxide.

Alkali earth metal hydroxides (Ca, Sr, Ba, Ra) can also be used. From the practical point of view, however, a base should be selected from the former group of materials, which are less costly and yet effective. When sodium hydroxide is used, it is preferable to prepare an aqueous solution containing a sodium hydroxide concentration of 0.1 to 10%. In the case of using soda ash, it is also preferable to prepare an aqueous solution containing a soda ash concentration of 0.1 to 10%. The dipping time is several minutes at ordinary temperature. After the dipping treatment, rinsing with water is generally performed. In case of a metal part made from an aluminum-containing alloy or from aluminum itself, dipping in the basic aqueous solution allows the aluminum or magnesium alloys surface to dissolve into aluminate ions while releasing hydrogen. As a result, the aluminum alloy surface becomes a finely etched surface.

As per the (ii) Neutralization (Acid) Treatment, this step consists in dipping at least part of the surface of a shaped metal part in an acid aqueous solution. Accordingly, any acid aqueous solution conformable to the above-described purpose is usable. More specifically, dilute nitric acid is preferable. For aluminum alloy containing silicon, it is also preferable to add hydrofluoric acid for the purpose of silicon oxide measures. It is preferable that the concentration of nitric acid (HNO₃) should be of the order of several percent, and the concentration of hydrofluoric acid (aqueous solution of liquid hydrogen fluoride) should be from 0 to 1.0%. Next, the surface of the said shaped metal part is generally rinsed with water.

It is generally understood that a step of (iii) Neutralization (Acid) Treatment will be generally be used in combination pursuant to a previous (i) Alkali Etching, as above detailed. The purpose of using an acid aqueous solution in this case is to effect neutralization. If sodium hydroxide or the like is left unremoved from the surface of the shaped aluminum alloy material in the previous process, it is expected that the remaining sodium hydroxide will accelerate corrosion of the shaped aluminum alloy material when used as a product. Therefore, neutralization is necessary. In addition, metals forming a solid solution with the aluminum alloy, e.g. magnesium, copper, and silicon, are not completely dissolved by the pretreatment process using a basic aqueous solution but remain in the form of hydroxides or other compositions in the vicinity of the surface. These substances can also be removed by dipping in the acid aqueous solution.

As per the (iii) T-treatment (contact treatment), this can be effected in general either through an (j) Aqueous Solution Dipping Process or through (jj) a Gas Contact Process.

When using an (j) Aqueous Solution Dipping Process, an aqueous solution dipping process is used in which at least a part of the surface of the shaped metal article is dipped in an aqueous solution of at least one selected from the group consisting of ammonia (NH₃), hydrazine (N₂H₄), a hydrazine derivative, and a water-soluble amine compound. For an aqueous solution of ammonia, commercially available aqueous ammonia is usable as it is or in the form of a dilute solution. When hydrazine is used, commercially available hydrazine hydrate or 60% hydrazine aqueous solution is usable as a raw material for a dilute solution. It is also possible to use an aqueous solution of a hydrazine derivative, e.g. an aqueous solution of carbodihydrazide (NH₂—NH—CO—NH—NH₂).

As a water-soluble amine compound, lower amines are usable. Particularly preferable lower amines are methylamine (CH₃NH₂), dimethylamine ((CH₃)₂NH), trimethylamine ((CH₃)₃N), ethylamine (C₂H₅NH₂), diethylamine ((C₂H₅)₂NH), triethylamine ((C₂H₅)₃N), ethylene diamine (H₂NCH₂CH₂NH₂), ethanol amine (mono-ethanol amine (HOCH₂CH₂NH₂), aryl amine (CH₂CHCH₂NH₂), diethanol amine ((HOCH₂CH₂)₂NH), etc. These compounds are dissolved in water when used.

The concentration of the above-described compound in an aqueous solution to be used is of the order of 2 to 30%. The dipping time is from several minutes to 30 minutes at a temperature in the range of from ordinary temperature to 60° C. If ammonia is used, for example, it is preferable to perform dipping in the aqueous solution containing an ammonia concentration of 10 to 30% for 15 to 120 minutes under ordinary temperature conditions. After being dipped in an aqueous solution of at least one of the above-mentioned compounds, the shaped aluminum alloy material is rinsed with water and then dried.

When the said surface of the said shaped metal article is dipped in the aqueous ammonia solution, aluminum possibly present in the alloy dissolves into aluminate ions while releasing hydrogen bubbles. As a result, the aluminum alloy surface becomes a finely etched surface. Similar phenomena occur when a magnesium containing alloy shaped article is used. Without being bound by this theory, X-ray photoelectron spectroscopy (XPS) analysis can demonstrate that nitrogen species are present on the surface of the said shaped metal article, which are believed to be particularly effective in ensuring adhesion to the overmolded layer.

When using a (ii) Gas Contact Process, at least a part of the surface of the shaped metal article is brought into contact with a gas produced by gasifying at least one of ammonia (NH₃), hydrazine (N₂H₄), pyridine (C₅H₅N), and an amine compound. The purpose of this process is to adsorb such a nitrogen-containing compound on the shaped aluminum alloy material prepared in the previous process. Preferable nitrogen-containing compounds are those which may be regarded as amine compounds in a broad sense, such as ammonia, hydrazine, pyridine, methylamine (CH₃NH), dimethylamine ((CH₃)₂NH), trimethylamine ((CH₃)₃N), ethylamine (C₂H₅NH₂), diethylamine ((C₂H₅)₂NH), triethylamine ((C₂H₅)₃N), ethylene diamine (H₂NCH₂CH₂NH₂), ethanol amine (mono-ethanol amine (HOCH₂CH₂NH₂), aryl amine (CH₂CHCH₂NH₂), diethanol amine ((HOCH₂CH₂)₂NH), triethanol amine ((HOCH₂CH₂)₃N), aniline (C₆H₇N), and other amines.

According to a first embodiment, the pre-treatment include a sequence of etching process comprising a first (i) Alkali Etching; a second (ii) Neutralization (Acid) Treatment; and a third (iii) T-treatment (contact treatment), followed by a step (iv) of rinsing and drying. This embodiment corresponds to the pre-treatment known as NMT-method, as mentioned above. Within the frame of this invention, the expression NMT-method will be used for designating the aforementioned sequence of four successive steps, as detailed above.

A detailed description of these four steps of the NMT-method is available notably in the Master Thesis, entitled “‘Nano Molding Technology on Cosmetic Aluminum Parts in Mobile Phones—an experimental study’, by Carl-Ola Annefors and Sara Petersson for Division of Production and Materials Engineering at Lund University, the whole content of which is herein incorporated by reference, and in European Patent Applications EP1459882 and EP1559542, the whole content of those are herein incorporated by reference, as mentioned above.

According to said first embodiment, the aforementioned four steps may be carried out on the shaped metal article as such, or can be applied after having performed one or more of (1) cleaning; and (2) mechanically roughening steps, as above detailed.

According to certain embodiments, the forming of layer (C) in Step 2, as described above, can also notably be realized on smooth substrates of said shaped metal part, treated only by washing to remove grease and other contaminants which might interfere with the bonding of said layer (C), yielding good bonding properties.

For the purpose of the present invention, the shape of the metal part can be formed by various machining process, known in the art, into a configuration which is desired and fits best its encompassed end use in a mobile electronic device, and for use as an insert in injection molding process, as described in a preferred embodiment below.

For example, the shaped aluminum alloy part can be configured into the desired configuration from an aluminum alloy ingot, plate, bar or the like by machining processes including for example plastic working, sawing, milling, electrical discharge machining, drilling, press working, grinding, or polishing, which may be used singly or in combination.

If desired, the pre-treated shaped metal part, as described above, can still be further shaped by applying standard shaping technologies before carrying out Step 2.

The pre-treated shaped metal part as obtained in Step 1 has a surface which can be intended to be partially or totally affixed to layer (C), as formed in Step 2 of the present invention.

It is generally understood that the pre-treated shaped metal part as obtained in Step 1 is advantageously submitted to Step 2 without further delay, so as to avoid surface to de-activate/undergo passivation again. Generally, the pre-treated shaped metal part as obtained in Step 1 is stored under dry air conditions. The storage period of time should preferably be shortened as much as possible. However, it is generally understood that storage time within one week at ordinary temperature (below 30° C.) under dry air conditions will maintain pre-treatment effects.

### Overmolding Step—Step 2

As said, in Step 2 of the method of the present invention, the composition (C), as described in detail above, is overmolded onto said pre-treated shaped metal part, as described in detail above, by using conventional overmolding techniques. Said conventional overmolding techniques are known on the art and typically include but not limited to injection molding, heat pressing, compression molding, sintering, machining, or combinations thereof. Injection molding is especially preferred.

The injection molding can typically be carried out according to standard methods known in the art, all experimental parameters can be applied according to ordinary practice in the art.

It is further understood that the injection molding process as described in detail in the section “Injection Molding” of the Master Thesis, by Carl-Ola Annefors and Sara Petersson, as mentioned above, can also be applied in Step 2 of the method of the present invention, it is understood that the skilled person will easily adapt the experimental parameters which fits best to the needs of the present invention.

In a preferred embodiment of Step 2 of the method of the present invention, the composition (C), as described in detail above, is molded over the at least pre-treated shaped aluminium alloy part by using conventional overmolding techniques chosen from injection molding, heat pressing, extruding and combinations thereof, thereby forming a layer (C) onto said pre-treated shaped metal part.

The external surface of layer (C) may have any feature, shape, size, etc., necessary to its function, regardless of the shape and size of underlying pretreated shaped metal part.

Machining of metals and plastics include laser cutting, welding, friction stir welding, ultrasonic welding, flame and plasma cutting, bending, spinning, hole-punching, pinning, gluing, fabric cutting, sewing, tape and fiber placement, routing, picking and placing (PnP), and sawing. Computer numerical controlled machining involves performing specific machining on mills typically consisting of a table that moves in the X and Y axes, and a tool spindle that moves in the Z (depth). The position of the tool is driven by motors through a series of step-down gears in order to provide highly accurate movements, and in modern designs, direct-drive stepper motor or servo motors.

The Applicant has surprisingly found that overmolding onto said pre-treated shaped metal part by a composition (C) comprising the (PESU) polymer is very advantageous because the (PESU) polymer provides (i) excellent bonding of the final layer (C) to the pre-treated shaped metal part, good mechanical properties of said final layer (C) and iii) good chemical resistance to anodization if that is required.

The composition (C), as described above, can be prepared by a variety of methods involving intimate admixing of the at least (PESU) polymer, optionally the reinforcing fillers, as described above, and optionally the other ingredients, as detailed above, desired in the formulation, for example by melt mixing or a combination of dry blending and melt mixing. Typically, the dry blending of the at least one (PESU) polymer, optionally the reinforcing filler and optionally the other ingredients, as above details, is carried out by using high intensity mixers, such as notably Henschel-type mixers and ribbon mixers.

So obtained powder mixture of said composition (C) can suitable be used in Step 2 of the method of the present invention, as described above, or the obtained powder mixture can be a concentrated mixture to be used as masterbatch and diluted in further amounts of the at least (PESU) polymer, optionally the reinforcing fillers, as described above, and optionally the other ingredients, as detailed above, in Step 2 of the method of the present invention.

It is also possible to manufacture composition (C) of the invention by further melt compounding the powder mixture as above described. As said, melt compounding can be effected on the powder mixture as above detailed, or directly on the at least (PESU) polymer, optionally the reinforcing fillers, as described above, and optionally the other ingredients, as detailed above. Conventional melt compounding devices, such as co-rotating and counter-rotating extruders, single screw extruders, co-kneaders, disc-pack processors and various other types of extrusion equipment can be used. Preferably, extruders, more preferably twin screw extruders can be used.

If desired, the design of the compounding screw, e.g. flight pitch and width, clearance, length as well as operating conditions will be advantageously chosen so that sufficient heat and mechanical energy is provided to advantageously fully melt the powder mixture or the ingredients as above detailed and advantageously obtain a homogeneous distribution of the different ingredients. Provided that optimum mixing is achieved between the bulk polymer and filler contents. It is advantageously possible to obtain strand extrudates which are not ductile of the composition (C) of the invention. Such strand extrudates can be chopped by means e.g. of a rotating cutting knife after some cooling time on a conveyer with water spray. Thus, for example composition (C) which may be present in the form of pellets or beads can then be further used in Step 2 of the method of the present invention, as discussed above.

The mobile electronic parts according to the present invention may be further shaped into in a part having any type of size and shape by applying standard shaping technologies.

According to certain embodiments, the method for the manufacture of the above described mobile electronic parts further comprises an anodization treatment thereby forming an anodized mobile electronic part.

It is understood that said anodization treatment can be carried out on the mobile electronic parts, as formed in Step 2 of the method of the present invention, before or after the further shaping of said mobile electronic parts.

Said anodizing treatment can be carried out according to various conventional methods. In general, an anodizing treatment is carried out in four steps including a pre-treatment, an anodizing, a coloring and a sealing, where the pre-treatment is divided into three process steps: degreasing, etching and desmutting. After each step, rinsing the parts in water is recommended. For example, the anodizing step is carried out in an acid medium such as a sulfuric acid solution or a sulfuric acid containing sulfophthalic acid solution according to well known procedures.

Another aspect of the present invention is the anodized mobile electronic part, as described above.

Another objective of the present invention is to provide a method for the manufacture of a mobile electronic device comprising the mobile electronic part, as described in detail above, said method including the steps of:
providing as components at least a circuit board, a screen and a battery;
providing at least one mobile electronic part, as described above;
assembling at least one of said components with said part or mounting at least one of said components on said part.

Should the disclosure of any patents, patent applications, and publications which are incorporated herein by reference conflict with the description of the present application to the extent that it may render a term unclear, the present description shall take precedence.

### EXAMPLES

The invention will now be described in more details with reference to the following examples, whose purpose is merely illustrative and not intended to limit the scope of the invention.

### Raw Materials

Aluminum alloy plate A5052/H38 as purchased from Alcoa Inc. Pretreated Aluminum plates with a nano porous surface can be obtained from TaiseiPlas, Japan. Virantage® 10200, Virantage® 10300, and Virantage® 10700 commercially available from Solvay Specialty Polymers USA, LLC.

### Example 1

A metal substrate, e.g. commercially available aluminum alloy plate A5052/H38 with a thickness of 1 mm, is stamped into a part used in mobile electronics, e.g. cover, frame, backing. Said aluminum alloy part is dipped in 1 liter of ethanol for 10 minutes under application of ultrasonic waves, and then is dipped in 4 liters of tap water under stirring. Thereafter, the aluminum alloy part is put into a plastic basket and washed with running tap water. Next, the aluminum alloy part is dipped in a 2% aqueous caustic soda solution for 2 minutes, followed by rinsing with ion-exchange water. Then, the aluminum alloy part is dipped in a 1% aqueous hydrochloric acid solution for 1 minute to effect neutralization. Then, the aluminum alloy part is dip-washed in 4 liters of ion-exchange water, followed by rinsing with running ion-exchange water.

One liter of a 2% aqueous ammonia solution is prepared. A 1% aqueous caustic soda solution prepared separately is dropped into the aqueous ammonia solution under stirring to adjust the pH to 11.0 at 50° C. The treated aluminum alloy part, as stated above, is dipped in this prepared aqueous solution for 2 minutes and then thoroughly washed with ion-exchange water. The aluminum alloy part is dried with hot air at 60° C. for 20 minutes.

The treated Aluminum substrate can be overmolded by inserting in place the Aluminum substrate in to a heated mold at a temperature of 100-110° C. in an injection molding machine. The typical molding conditions are shown in the Table below,

| Zones | T (° F.) |
|---|---|
| Rear | 656 |
| Front | 656 |
| Nozzle | 650 |

The reactive PESU materials, Virantage® 10200, Virantage® 10300, and Virantage® 10700 are injected into the mold at a melt temperature of 656-715° F. The typical injection time for the molten polymer is 6 s and the cycle time for molding is 15 s.

### Example 2

A metal substrate, e.g. commercially available aluminum alloy plate A5052/H38 with a thickness of 1 mm, is stamped into a part used in mobile electronics, e.g. cover, frame, backing. Said aluminum alloy part is dipped in 1 liter of ethanol for 10 minutes under application of ultrasonic waves, and then thoroughly washed with ion-exchange water. The aluminum alloy part is dried under Nitrogen. The aluminum alloy substrate is then placed in plasma chamber and is subjected to an Oxygen plasma for 10 minutes and then taken out from the plasma chamber and then hermetically sealed in foil lined bags. The plasma treated parts are then overmolded by inserting in place the Aluminum substrate in to a heated mold at a temperature of 100-110° C. in an injection molding machine.

The typical molding conditions are shown in the table below,

| Zones | T (° F.) |
|---|---|
| Rear | 656 |
| Front | 656 |
| Nozzle | 650 |

The reactive PESU materials, Virantage® 10200, Virantage® 10300, and Virantage® 10700 are injected into the mold at a melt temperature of 656-715° F. The typical injection time for the molten polymer is 6 s and the cycle time for molding is 15 s.

1-15. (canceled)

16. A mobile electronic part comprising:
(i) a pre-treated shaped metal part wherein the metal is selected from the group consisting of magnesium, aluminium, and alloys of these metals; and
(ii) an overmolded composition layer (C), bonded onto the pre-treated shaped metal part wherein the composition layer (C) comprises at least one poly(ethersulfone) polymer (PESU).

17. The mobile electronic part according to claim 16, wherein the (PESU) polymer comprises more than 50% by moles of recurring units (R_{PESU}) of formula (A):

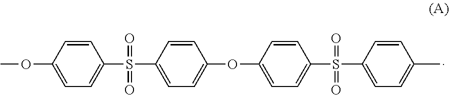

18. The mobile electronic part according to claim 16, wherein the (PESU) polymer has a melt flow rate (MFR) equal to or higher than 20 g/10 min at 380° C. and under a load of 2.16 kg.

19. The mobile electronic part according to claim 16, wherein the (PESU) polymer is functionalized by one or more functional groups.

20. The mobile electronic part according to claim 19, wherein the functional group is selected from a group consisting of an hydroxyl, a carboxyl of formula —COOA, wherein A is hydrogen or an alkali metal, anhydride, and epoxide group.

21. The mobile electronic part according to claim 20, wherein the hydroxyl group is a phenol OH group and the number of phenol OH groups is equal to or more than 10 μeq/g.

22. The mobile electronic part according to claim 16, wherein the thickness of the composition layer (C) is of at most 3000 μm.

23. The mobile electronic part according to claim 16, wherein the mobile electronic part is selected from a group consisting of fitting parts, snap fit parts, screw bosses parts, mutually moveable parts, functional elements, operating elements, tracking elements, adjustment elements, carrier elements, frame elements, films, in particular speaker films, switches, connectors, cables, housings, any structural part integrated on housings, and any other structural part other than housings as used in a mobile electronic devices.

24. The mobile electronic part according to claim 16, wherein the mobile electronic part is further shaped into a finished part having any type of size and shape.

25. The mobile electronic part according to claim 16, wherein said mobile electronic part has been anodized.

26. A method for manufacturing the mobile electronic part according to claim 16 comprising the following steps:
Step 1—pre-treatment of at least part of the surface of a shaped metal part to form the pre-treated shaped metal part; and
Step 2—forming the overmolded composition layer (C) onto the pre-treated shaped metal part by overmolding the composition layer (C) onto the pre-treated shaped metal part by using an overmolding process.

27. The method according to claim 26, wherein the overmolding process is selected from the group consisting of injection molding, heat pressing, compression molding, sintering, machining, or combinations thereof.

28. The method according to claim 26, which further comprises an anodization treatment step.

29. A mobile electronic device comprising the mobile electronic part according to claim 16.

30. A method for manufacturing a mobile electronic device according to claim 29, the method including the steps of:
providing as components at least a circuit board, a screen, and a battery;
providing at least one mobile electronic part, according to claim 16;
assembling at least one of the components with the at least one mobile electronic part, or mounting at least one of the components on the at least one mobile electronic part.
